(19) United States
(12) Patent Application Publication
(10) Pub. No.: US 2010/0203098 A1
(43) Pub. Date: Aug. 12, 2010

(54) Dust Composition for Combating Insects

(75) Inventor: Scott Kleinschmidt, Queensland (AU)

Correspondence Address: BRINKS, HOFER, GILSON & LIONE, P.O. BOX 1340, MORRISVILLE, NC, 27560, US

(73) Assignee: BASF SE, Ludwigshafen (DE)

(21) Appl. No.: 12/678,413

(22) PCT Filed: Sep. 18, 2007
(86) PCT No.: PCT/EP07/59833

§ 371 Date: Mar. 16, 2010

(51) Int. Cl. A01N 43/56; A01N 43/24; A01N 43/60; A01N 43/40; A01N 25/08; A01P 7/04

(52) U.S. Cl. 424/409; 514/407; 514/431; 514/255.05; 514/341

(57) ABSTRACT

The present invention relates to a dust composition comprising at least one insecticide selected from GABA antagonists and at least one organic carrier selected from celluloses and cellulose derivatives. The invention further relates to the use of the dust composition for combating insects and to a method for controlling insects by bringing them, their food supply or their habitat, or the materials, soils, surfaces or spaces to be protected from insect attack or infestation into contact with the dust composition. The invention also relates to a method for protecting wood material from termite attack or infestation by bringing the wood material to be protected or a soil, surface or space near the wood material to be protected into contact with the dust composition.

The present invention relates to a dust composition comprising at least one insecticide selected from GABA antagonists and at least one organic carrier selected from celluloses and cellulose derivatives. The invention further relates to the use of the dust composition for combating insects and to a method for controlling insects by bringing them, their food supply or their habitat, or the materials, soils, surfaces or spaces to be protected from insect attack or infestation into contact with the dust composition. The invention also relates to a method for protecting wood material from termite attack or infestation by bringing the wood material to be protected or a soil, surface or space near the wood material to be protected into contact with the dust composition.

Animal pests and in particular insects destroy growing and harvested crops and attack wooden dwelling and commercial structures, causing large economic loss to the food supply and to property.

Control of soil living pests, in particular of existing termite infestations in structures and prevention of termite invasions is a difficult non-agricultural pest control problem. Control methods are tedious and labour intensive and therefore expensive. Termites are ubiquitous and forage constantly for new food sources. Wood or wood products in homes provide an inviting target if such foraging termites are undeterred or not removed. A widely accepted strategy to prevent termite infestation or control existing infestations is treatment of soil under or surrounding a structure. Treatment of the soil is generally effected by applying a liquid composition containing a termiticide to the soil where the structure touches the soil. By applying a liquid treatment a continuous or contiguous barrier is established wherein foraging termites that encounter it either are repelled or are contacted and receive a dose of termiticide. Pest control technicians are specifically directed to provide such barriers by applying large amounts of an aqueous termiticidal composition to the soil. Creating a thorough barrier is of utmost importance because foraging subterranean termites can detect gaps between application points and dig through them. Once a food source (i.e. the structure intended to be protected) is reached, a colony of termites can then be signalled to attack the food source and tunnel through the gap between applications.

WO 98/28973 discloses a process for protection of buildings against damage caused by insects, in particular termites, whereby an effective amount of an insecticidally active compound, preferably a 1-arylpyrazole compound, is spread around or under the building at discrete locations. The active compounds are applied as dilutions of conventional formulations.

However, the application of aqueous insecticide formulations to such areas may cause various problems, including microbial or fungal degradation of the building materials themselves. Therefore it is desirable to provide solid insecticidal formulations which do not damage the material to be protected.

Application of particulate termiticides is known. For example, U.S. Pat. No. 6,264,968 describes insecticidal compositions containing an insecticidally active compound selected from nicotinic acetylcholine receptor agonists or antagonists, phosphorus-containing compounds, pyrethroides, carbamates, amidines, juvenile hormones and juvenile hormone-like substances combined with an organic natural and/or synthetic compounds carrier material that delays degradation and release of the active ingredient.

US 2007/0157507 describes a particulate termiticidal composition comprising a termiticidally active ingredient preferably selected from nicotinic acetylcholine receptor agonists and antagonists and an inorganic carrier.

Arsenic trioxide-containing dusts have been used for nearly a century as termiticides.

However, the known solid formulations suffer from several drawbacks. For instance, arsenic trioxide is highly toxic for man and other mammals, too, and its application requires fastidious precaution measures from the pest control operator. Moreover, arsenic trioxide is repellent. As its termiticidal action is based on topical contact, the pest control operator generally has to find the nest for being able to bring enough termites into contact with the active substance. The other known dust formulations work only topically, too, and thus require that enough insects come into contact with a sufficient amount of the formulation. Moreover, in many insecticidal formulations the mortal effect on the insect is too fast, which prevents that the insect which has come into contact with the formulation returns to the nest and brings more insects into contact with the insecticidal formulation adhering to it.

It is an object of the present invention to provide a solid insecticidal formulation which overcomes the above-described drawbacks. In particular, the formulation should have a delayed mortal effect. Moreover, the formulation shall not only act topically, but also non-topically, e.g. when swallowed. Furthermore, the formulation shall allow a pest control operator to find the nest of the insects to be combated and their local extension.

The object is achieved by a dust composition, comprising

(i) at least one insecticide selected from GABA antagonists and

(ii) at least one organic carrier selected from celluloses and cellulose derivatives.

Insects, in particular wood-destroying insects, nourish on cellulosic material. Since the dust composition of the invention contains cellulose or a cellulose derivative as a main component, and since GABA antagonist insecticides are not repellent, the insects will be appealed to eat the composition and thus to incorporate the insecticide, in particular if the organic carrier is a cellulose. Accordingly, the insects can be combated not only by topical contact with the composition of the invention, but also non-topically by way of eating it.

The composition of the invention is a dust composition. In the terms of the present invention, “dusts” are defined as gas-dispersible, powdery solid materials. The solid particles can be of any shape, structure, and density. Dusts are characterized by having a small particle size, for example of at most 500 μm, preferably of at most 400 μm, more preferably of at most 300 μm, even more preferably of at most 200 μm and in particular of at most 100 μm. Particle size refers to the mean diameter of the particles. For non-spherical particles, the diameter is defined to be the longest extension of the particle.

Dust particles may also be characterized by having a relatively large specific surface area, such as up to several hundreds of m²/g. However, more characteristic is the particle size.

The GABA antagonists are preferably selected from acetoprole, endosulfan, vaniliprole, pyrafluprole, pyriprole, the phenylpyrazole compound of the formula II

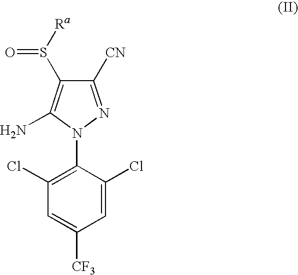

where R^{a} is C₁-C₄-alkyl or C₁-C₄-haloalkyl;

or an agriculturally acceptable salt thereof;

and the phenylpyrazole compound of the formula III

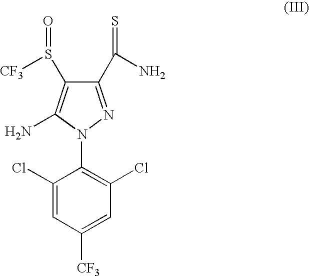

or an agriculturally acceptable salt thereof.

The organic moieties mentioned in the above definitions of the variables are—like the term halogen—collective terms for individual listings of the individual group members. The prefix Cₙ-Cₘ indicates in each case the possible number of carbon atoms in the group.

Halogen will be taken to mean fluoro, chloro, bromo and iodo, preferably fluoro, chloro, and bromo and in particular fluoro and chloro.

C₁-C₄-alkyl is a linear or branched alkyl group having 1 to 4 carbon atoms. Examples are methyl, ethyl, propyl, isopropyl, n-butyl, sec-butyl, isobutyl and tert-butyl.

C₁-C₄-haloalkyl is a linear or branched alkyl group having 1 to 4 carbon atoms, as defined above, wherein at least one hydrogen atom is replaced by a halogen atom. Examples are chloromethyl, bromomethyl, dichloromethyl, trichloromethyl, fluoromethyl, difluoromethyl, trifluoromethyl, chlorofluoromethyl, dichlorofluoromethyl, chlorodifluoromethyl, 1-chloroethyl, 1-bromoethyl, 1-fluoroethyl, 2-fluoroethyl, 2,2-difluoroethyl, 2,2,2-trifluoroethyl, 2-chloro-2-fluoroethyl, 2-chloro-2,2-difluoroethyl, 2,2-dichloro-2-fluoroethyl, 2,2,2-trichloroethyl, pentafluoroethyl and the like.

Owing to the basic nitrogen atoms in the azole moieties, some of the GABA antagonist insecticides (for example compounds II and III described above) are capable of forming salts or adducts with inorganic or organic aids or with metal ions. They can be formed in a customary method, e.g. by reacting the compounds with an acid of the anion in question.

Suitable agriculturally useful salts are especially the salts of those cations or the acid addition salts of those acids the cations and anions of which do not have any adverse effect on the action of the compounds according to the present invention. Suitable cations are in particular the ions of the alkali metals, preferably lithium, sodium and potassium, of the alkaline earth metals, preferably calcium, magnesium and barium, and of the transition metals, preferably manganese, copper, zinc and iron, and also ammonium (NH₄⁺) and substituted ammonium in which one to four of the hydrogen atoms are replaced by C₁-C₄-alkyl, C₁-C₄-hydroxyalkyl, C₁-C₄-alkoxy, C₁-C₄-alkoxy-C₁-C₄-alkyl, hydroxy-C₁-C₄-alkoxy-C₁-C₄-alkyl, phenyl or benzyl. Examples of substituted ammonium ions comprise methylammonium, isopropylammonium, dimethylammonium, diisopropylammonium, trimethylammonium, tetramethylammonium, tetraethylammonium, tetrabutylammonium, 2-hydroxyethylammonium, 2-(2-hydroxyethoxy)ethylammonium, bis(2-hydroxyethyl)ammonium, benzyltrimethylammonium and benzyltriethylammonium, furthermore phosphonium ions, sulfonium ions, preferably tri(C₁-C₄-alkyl)sulfonium, and sulfoxonium ions, preferably tri(C₁-C₄-alkyl)sulfoxonium.

Anions of useful acid addition salts are primarily chloride, bromide, fluoride, hydrogen sulfate, sulfate, dihydrogen phosphate, hydrogen phosphate, phosphate, nitrate, hydrogen carbonate, carbonate, hexafluorosilicate, hexafluorophosphate, benzoate, and the anions of C₁-C₄-alkanoic acids, preferably formiate, acetate, propionate and butyrate. They can be formed by reacting the compounds of the formulae I or II or III (as to compounds II and III see below) with an acid of the corresponding anion, preferably of hydrochloric acid, hydrobromic acid, sulfuric acid, phosphoric acid or nitric acid.

Preferably, the GABA antagonists are selected from compounds of formula II.

In compounds II, R^{a} is preferably ethyl or trifluoromethyl. The compound where R^{a} is ethyl is also known under the common name ethiprole and the compound where R^{a} is trifluoromethyl is known under the common name fipronil. More preferably, R^{a} is trifluoromethyl. Thus, the GABA antagonist insecticide is in particular fipronil.

GABA antagonists and methods for producing them are generally known. For instance, the commercially available compounds may be found in The Pesticide Manual, 13^{th} Edition, British Crop Protection Council (2003) among other publications.

The organic carrier of the composition of the invention is a cellulose or a cellulose derivative. As a matter of course, the carrier material is in dust form in the composition of the invention. Cellulose, the most widely spread biopolymer, is a polysaccharide of the formula (C₆H₁₀O₅)ₙ and is more precisely an isotactic β-1,4-polyacetal of cellobiose, which in turn is formed of two D-glucose molecules condensed through β-(1→4)-glycosidic bonds. Cellulose is classified into α-, β- and γ-cellulose, the two latter forms also being known as hemicellulose. α-Cellulose is the fraction which is not soluble in 17.5% aqueous NaOH or 24% aqueous KOH and has an average degree of polymerization (DP) of >200. β-Cellulose is the fraction which can be precipitated from the NaOH solution with methanol and γ-cellulose is the fraction which can not. The hemi-celluloses also contain polyoses and/or degraded short-chain cellulose.

The cellulose carrier is preferably α-cellulose.

Suitable cellulose derivatives are cellulose esters with carboxylic acids such as acetic acid, propionic acid and butyric acid, and cellulose ethers with C₁-C₃ mono- and dihydric alcohols. Preferred cellulose esters are selected from cellulose acetate and mixed cellulose acetate/propionate and cellulose acetate/butyrate. More preferred is cellulose acetate. Preferred cellulose ethers are selected from methylcellulose, ethylcelluose, hydroxyethylcellulose, hydroxypropylcellulose, hydroxyethylmethylcellulose, hydroxyethylethylcellulose and hydroxypropylethylcellulose. Among the above cellulose derivatives, cellulose esters are preferred, cellulose acetate being particularly preferred.

In a preferred embodiment of the invention, the organic carrier is selected from celluloses and cellulose derivatives which are edible (and, of course, not repellent), preferably edible for insects, more preferably for insects which destroy or damage industrial materials, in particular wood and timber products, and in particular for termites. Preferred edible organic carriers are selected from celluloses, particular preference being given to α-cellulose.

In an alternatively preferred embodiment of the invention, the organic carrier is selected from cellulose derivatives. As to suitable and preferred cellulose derivatives, reference is made to the above remarks. In this embodiment, and in particular in case the cellulose derivative is cellulose acetate, the dust composition of the invention preferably also contains the below-described component (iii).

In a particularly preferred embodiment of the invention, the organic carrier is selected from α-cellulose and cellulose acetate and specifically is α-cellulose.

Cellulose and cellulose derivatives in dust form are commercially available. Alternatively, the dust form can be prepared by submitting granules, a powder or crystalline form to a grinding, milling or other process for comminuting solid material known to those skilled in the art.

In the composition of the invention, the weight ratio of organic carrier to insecticide is preferably of from 10000:1 to 5:1, more preferably from 10000:1 to 9:1, even more preferably from 10000:1 to 20:1, particularly from 1000:1 to 50:1, more particularly from 1000:1 to 90:1 and specifically from 500:1 to 100:1.

In a preferred embodiment, the dust composition of the invention further comprises (iii) at least one fluorescent dye.

Fluorescent dyes are dyes which, in contrast to normal dyes (=dyes without fluorescent properties), do not only absorb light, but also emit it. In general, fluorescent dyes absorb light at a first wavelength and emit at a second wavelength which is longer than the first wavelength. If the emitted light is in the visible spectrum, the fluorescence dyes generally produce exceptionally bright colours. Fluorescence occurs when molecules that have absorbed light and are in their lowest excited state S₁ return to their ground state S₀ and emit light. Some of the absorbed light energy activates nuclear vibrations and is released as heat. Further energy is lost due to the conversion of the lowest excited state S₁ to a triplet state T₁ (intersystem crossing) and is not available for fluorescence. Thus, the emitted light has a lower energy (=a longer wavelength) than the absorbed light.

Fluorescent dyes in the proper sense absorb and emit light in the visible region of the spectrum. However, “fluorescent dyes” as used in terms of the present invention also encompass substances which absorb in the invisible UV region and emit blue to blue-violet light or UV-light and which are usually termed “optical brighteners ” or “fluorescent brighteners”.

Fluorescent dyes are in most cases organic molecules with extremely rigid, extended π-systems. Rigidity is of importance because it suppresses the release of energy due to activated nuclear vibrations. Substituents such as heavy atoms (chlorine and bromine) or nitro groups are detrimental to fluorescence because they favour intersystem crossing.

Fluorescent dyes also encompass fluorescent pigments.

Pigments are generally defined as being a specific class of dyes, namely dyes which are not soluble in the (liquid) application medium.

Fluorescent pigments usually consist of finely divided matrix particles that contain fluorescent dyes. Their luminosity and brilliance make them particularly useful if intense or long-distance visibility is needed. Daylight fluorescent pigments absorb UV and visible light from daylight and reemit it at a higher wavelength as visible radiation. As a rule, the time interval between light absorption and emission is very short (about 10⁻⁸ s), and the fluorescence persists only in the presence of an exciting light source. UV fluorescent pigments only fluoresce under UV light.

According to the above definition, fluorescent pigments can also be defined as being fluorescent dyes insoluble in a liquid application medium (i.e. without necessarily containing a particulate matrix). However, as the fluorescent dyes are used in a dust, i.e. in a solid composition, it is of no relevance whether the dye is soluble or insoluble in a liquid medium. Therefore, in the terms of the present invention, no distinction is made between soluble dyes and insoluble pigments not containing matrix particles.

Examples for suitable fluorescent dye classes are naphthalenes, anthracenes, phenanthrenes, tetracenes, perylenes, terrylenes, quaterrylenes, pentarylenes, hexarylenes, naphtholactams, azlactones, methines, acridines, carbazoles, dibenzofurans, dinaphthofurans, benzimidazoles, benzothiazoles, phenazines, oxazines, thiazones, dioxazines, quinacridones, coumarins, dibenzofuranones, dinaphthofuranones, benzimidazolones, xanthenes, thioxanthenes, indigo compounds, thioindigo compounds, quinophthalones, naphthoquinophthalones and diketopyrrolopyrroles. Naphthalenes, anthracenes, phenanthrenes, tetracenes, perylenes, terrylenes, quaterrylenes, pentarylenes and hexarylenes preferably carry one or more, e.g. 1, 2, 3 or 4 carboxylic or carboxylic derivative groups, such as carboxyl (COON), a carboxylic amide group, a carboxylic ester group, a carboxylic anhydride group or a carboxylic imide group. Imide groups are most frequent. Such dyes are often called naphth(yl)imides, anthraceneimides, phenanthreneimides, tetraceneimides, peryleneimides, terryleneimides, quaterryleneimides, pentaryleneimides and hexaryleneimides. Preferred fluorescent dyes classes are naphthalenes (in particular naphthylimides), perrylenes (perylenes and perylenimides), terrylenes (terrylenes and terryleneimides), quaterrylenes (quaterrylenes and quaterryleneimides), coumarins, xanthenes, thioxanthenes, naphtholactams, azlactones, methines, oxazines, thiazines and thioindigoid. More preferred classes are naphthalenes (in particular naphthylimides) and perrylenes (perylenes and perylenimides).

Fluorescent dyes and methods for preparing them are well known in the art and are for example described in Ullmann's Encyclopedia of Industrial Chemistry, 5^{th} edition on CD ROM, 1997, Wiley-VCH, Weinheim, Germany and in the literature cited therein.

Suitable matrices for fluorescent pigments are all materials to which fluorescent dyes can bind. Moreover, the resulting fluorescent pigment should allow its processing to a dust. Usually, the matrix is an organic polymer or resin, such as toluenesulfonamidemelamine-formaldehyde resins, benzoguanamine-formaldehyde resins, urethane resins, polyamides, polyesters, polyvinylchlorides, polycarbonates, polyacrylates (in particular polymethylacrylates) and polymethacrylates (in particular polymethylmethacrylates). Preferred matrices are polyamides, polyesters, polyvinylchlorides, polycarbonates, polyacrylates (in particular polymethylacrylates) and polymethacrylates (in particular polymethylmethacrylates).

Fluorescent pigments and matrices therefor as well as methods for preparing them are well known in the art and are for example described in Ullmann's Encyclopedia of Industrial Chemistry, 5^{th} edition on CD ROM, 1997, Wiley-VCH, Weinheim, Germany and in the literature cited therein.

Examples of commercially available fluorescent dyes are the Lumogen® brands of BASF AG, Ludwigshafen, Germany, such as Lumogen F Yellow (a perrylene), e.g. Lumogen F Yellow 083, Lumogen F Orange (a perrylene), e.g. Lumogen F Orange 240, Lumogen F Red (a perrylene), Lumogen F Violet (a naphthylimide), Lumogen F Blue (a naphthylimide) and Lumogen Yellow SO 790, further Hostasol Yellow 3G, Oraset Yellow 8GF, Fluorol 088 (BASF), Thermoplast F Yellow 084 (BASF), Golden Yellow D-304 (DayGlo, Cleveland, Ohio), Mohawk Yellow D-299 (DayGlo, Cleveland, Ohio), Potomac Yellow D-838 (DayGlo, Cleveland, Ohio), Polyfast Brilliant Red SB (Keystone, Chicago, Ill.), CI Solvent Yellow 98, CI Solvent Yellow 160:1, CI Solvent Green 4, CI Solvent Green 5, CI Pigment Yellow 101, Golden Yellow D304 (Day-Glo, Cleveland, Ohio), and CI Solvent Yellow 131. Preferred fluorescent dyes are the above Lumogen brands. Fluorescent pigments (with a matrix) are also commercially available.

Specifically, component (iii) is a fluorescent pigment without matrix, for example Lumogen Yellow SO 790.

In the composition of the invention, the weight ratio of organic carrier to fluorescent dye or pigment is preferably of from 10000:1 to 10:1, more preferably from 10000:1 to 20:1, even more preferably from 10000:1 to 50:1, particularly from 10000:1 to 90:1, more particularly from 10000:1 to 100:1 and specifically from 5000:1 to 500:1.

The presence of the fluorescent dye in the composition of the invention has the advantage that it marks the insects which have come into contact with it. This allows a pet control operator to follow the insects' traces, which either fluoresce at daylight or in the light of a lamp emitting visible light or a UV lamp, and thus to find their nest. This in turn allows combating the insects directly in their nest and thus in a concentrated and effective manner. Following the insects' trace also helps finding out their local extension, which of course also helps combating them.

The dust composition of the invention may contain further ingredients, such as further insecticides (different from the at least one GABA antagonist insecticide), microbiocides, further solid carriers and antibaking agents.

It is matter of course that the further ingredients must be processable to dust form.

Further solid carriers are, for example, mineral earths such as silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers such as, for example, ammonium sulfate, ammonium phosphate, ammonium nitrate, ureas and plant products such as cereal meal, tree bark meal, wood meal and nutshell meal.

Suitable further insecticides are for example:

A.1. Organo(thio)phosphates: acephate, azamethiphos, azinphos-ethyl, azinphos-methyl, chlorethoxyfos, chlorfenvinphos, chlormephos, chlorpyrifos, chlorpyrifos-methyl, coumaphos, cyanophos, demeton-S-methyl, diazinon, dichlorvos/DDVP, dicrotophos, dimethoate, dimethylvinphos, disulfoton, EPN, ethion, ethoprophos, famphur, fenamiphos, fenitrothion, fenthion, flupyrazophos, fosthiazate, heptenophos, isoxathion, malathion, mecarbam, methamidophos, methidathion, mevinphos, monocrotophos, naled, omethoate, oxydemeton-methyl, parathion, parathion-methyl, phenthoate, phorate, phosalone, phosmet, phosphamidon, phoxim, pirimiphos-methyl, profenofos, propetamphos, prothiofos, pyraclofos, pyridaphenthion, quinalphos, sulfotep, tebupirimfos, temephos, terbufos, tetrachlorvinphos, thiometon, triazophos, trichlorfon, vamidothion;

A.2. Carbamates: aldicarb, alanycarb, bendiocarb, benfuracarb, butocarboxim, butoxycarboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, trimethacarb, XMC, xylylcarb, triazamate;

A.3. Pyrethroids: acrinathrin, allethrin, d-cis-trans allethrin, d-trans allethrin, bifenthrin, bioallethrin, bioallethrin S-cylclopentenyl, bioresmethrin, cycloprothrin, cyfluthrin, beta-, yfluthrin, cyhalothrin, lambda-cyhalothrin, gamma-cyhalothrin, cypermethrin, alpha-cypermethrin, beta-cypermethrin, theta-cypermethrin, zeta-cypermethrin, cyphenothrin, deltamethrin, empenthrin, esfenvalerate, etofenprox, fenpropathrin, fenvalerate, flucythrinate, flumethrin, tau-fluvalinate, halfenprox, imiprothrin, permethrin, phenothrin, prallethrin, resmethrin, RU 15525, silafluofen, tefluthrin, tetramethrin, tralomethrin, transfluthrin, ZXI 8901;

A.4. Juvenile hormone mimics: hydroprene, kinoprene, methoprene, fenoxycarb, pyriproxyfen;

A.5. Nicotinic receptor agonists/antagonists compounds: acetamiprid, bensultap, cartap hydrochloride, clothianidin, dinotefuran, imidacloprid, thiamethoxam, nitenpyram, nicotine, spinosad (allosteric agonist), thiacloprid, thiocyclam, thiosultap-sodium, and AKD1022.

A.6. Chloride channel activators: abamectin, emamectin benzoate, milbemectin, lepimectin;

A.7. METI I compounds: fenazaquin, fenpyroximate, pyrimidifen, pyridaben, tebufenpyrad, tolfenpyrad, flufenerim, rotenone;

A.8. METI II and III compounds: acequinocyl, fluacyprim, hydramethylnon;

A.9. Uncouplers of oxidative phosphorylation: chlorfenapyr, DNOC;

A.10. Inhibitors of oxidative phosphorylation: azocyclotin, cyhexatin, diafenthiuron, fenbutatin oxide, propargite, tetradifon;

A.11. Moulting disruptors: cyromazine, chromafenozide, halofenozide, methoxyfenozide, tebufenozide;

A.12. Synergists: piperonyl butoxide, tribufos;

A.13. Sodium channel blocker compounds: indoxacarb, metaflumizone;

A.14. Fumigants: methyl bromide, chloropicrin sulfuryl fluoride;

A.15. Selective feeding blockers: crylotie, pymetrozine, flonicamid;

A.16. Mite growth inhibitors: clofentezine, hexythiazox, etoxazole;

A.17. Chitin synthesis inhibitors: buprofezin, bistrifluron, chlorfluazuron, diflubenzuron, flucycloxuron, flufenoxuron, hexaflumuron, lufenuron, novaluron, noviflumuron, teflubenzuron, triflumuron;

A.18. Lipid biosynthesis inhibitors: spirodiclofen, spiromesifen, spirotetramat;

A.19. octapaminergic agonsits: amitraz;

A.20. ryanodine receptor modulators: flubendiamide;

A.21. Various: aluminium phosphide, amidoflumet, benclothiaz, benzoximate, bifenazate, borax, bromopropylate, cyanide, cyenopyrafen, cyflumetofen, chinomethionate, dicofol, fluoroacetate, phosphine, pyridalyl, pyrifluquinazon, sulfur, tartar emetic;

A.22. N—R′-2,2-dihalo-1-R″cyclo-propanecarboxamide-2-(2,6-dichloro-α,α,α-tri-fluoro-p-tolyl)hydrazone or N—R′-2,2-di(R′″)propionamide-2-(2,6-dichloro-α,α,α-trifluoro-p-tolyl)-hydrazone, wherein R′ is methyl or ethyl, halo is chloro or bromo, R″ is hydrogen or methyl and R′″ is methyl or ethyl;

A.23. Anthranilamides: chloranthraniliprole, the compound of formula Γ²

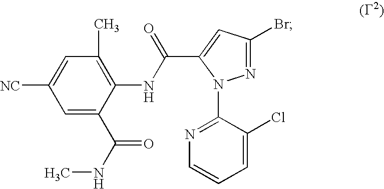

A.24. Malononitrile compounds: CF₃(CH₂)₂C(CN)₂CH₂(CF₂)₃CF₂H, CF₃(CH₂)₂C(CN)₂CH₂(CF₂)₅CF₂H, CF₃(CH₂)₂C(CN)₂(CH₂)₂C(CF₃)₂F, CF₃(CH₂)₂C(CN)₂(CH₂)₂(CF₂)₃CF₃, CF₂H(CF₂)₃CH₂C(CN)₂CH₂(CF₂)₃CF₂H, CF₃(CH₂)₂C(CN)₂CH₂(CF₂)₃CF₃, CF₃(CF₂)₂CH₂C(CN)₂CH₂(CF₂)₃CF₂H, CF₃CF₂CH₂C(CN)₂CH₂(CF₂)₃CF₂H, 2-(2,2,3,3,4,4,5,5-octafluoropentyl)-2-(3,3,4,4,4-pentafluorobutyl)-malonodinitrile, and CF₂HCF₂CF₂CF₂CH₂C(CN)₂CH₂CH₂CF₂CF₃;

A.25. Microbial disruptors: Bacillus thuringiensis subsp. Israelensi, Bacillus sphaericus, Bacillus thuringiensis subsp. Aizawai, Bacillus thuringiensis subsp. Kurstaki, Bacillus thuringiensis subsp. Tenebrionis;

The commercially available compounds of the group A may be found in The Pesticide Manual, 13^{th} Edition, British Crop Protection Council (2003) among other publications.

Thioamides of formula Γ¹ and their preparation have been described in WO 98/28279. Lepimectin is known from Agro Project, PJB Publications Ltd, November 2004. Benclothiaz and its preparation have been described in EP-A1 454621. Methidathion and Paraoxon and their preparation have been described in Farm Chemicals Handbook, Volume 88, Meister Publishing Company, 2001. Acetoprole and its preparation have been described in WO 98/28277. Metaflumizone and its preparation have been described in EP-A1 462 456. Flupyrazofos has been described in Pesticide Science 54, 1988, p. 237-243 and in U.S. Pat. No. 4,822,779. Pyrafluprole and its preparation have been described in JP 2002193709 and in WO 01/00614. Pyriprole and its preparation have been described in WO 98/45274 and in U.S. Pat. No. 6,335,357. Amidoflumet and its preparation have been described in U.S. Pat. No. 6,221,890 and in JP 21010907. Flufenerim and its preparation have been described in WO 03/007717 and in WO 03/007718. AKD 1022 and its preparation have been described in U.S. Pat. No. 6,300,348. Chloranthraniliprole has been described in WO 01/70671, WO 03/015519 and WO 05/118552. Anthranilamide derivatives of formula Γ² have been described in WO 01/70671, WO 04/067528 and WO 05/118552. Cyflumetofen and its preparation have been described in WO 04/080180. The aminoquinazolinone compound pyrifluquinazon has been described in EP A 109 7932. The malononitrile compounds CF₃(CH₂)₂C(CN)₂CH₂(CF₂)₃CF₂H, CF₃(CH₂)₂C(CN)₂CH₂(CF₂)₅CF₂H, CF₃(CH₂)₂C(CN)₂(CH₂)₂C(CF₃)₂F, CF₃(CH₂)₂C(CN)₂(CH₂)₂(CF₂)₃CF₃, CF₂H(CF₂)₃CH₂C(CN)₂CH₂(CF₂)₃CF₂H, CF₃(CH₂)₂C(CN)₂CH₂(CF₂)₃CF₃, CF₃(CF₂)₂CH₂C(CN)₂CH₂(CF₂)₃CF₂H, CF₃CF₂CH₂C(CN)₂CH₂(CF₂)₃CF₂H, 2-(2,2,3,3,4,4,5,5-octafluoropentyl)-2-(3,3,4,4,4-pentafluorobutyl)-malonodinitrile, and CF₂HCF₂CF₂CF₂CH₂C(CN)₂CH₂CH₂CF₂CF₃ have been described in WO 05/63694.

In a preferred embodiment of the invention, the dust composition of the invention does not contain further solid carriers or further insecticides. In a specific embodiment, the dust composition of the invention consists essentially of components (i), (ii) and optionally (iii). “Consists essentially” means that the composition may contain traces of water and other substances being present, for example, from the production or purification process or for stabilization purposes. These are preferably present in an amount of less than 5, more preferably of less than 2, even more preferably of less than 1, in particular of less than 0.5% by weight, based on the total weight of components (i), (ii) and (iiii).

The dust composition of the invention has a particle size of for example at most 500 μm, e.g. 0.1 μm to 500 μm or 1 μm to 500 μm, preferably of at most 400 μm, e.g. 0.1 μm to 400 μm or 1 μm to 400 μm, more preferably of at most 300 μm, e.g. 0.1 μm to 300 μm or 1 μm to 300 μm, even more preferably of at most 200 μm, e.g. 0.1 μm to 200 μm or 1 μm to 200 μm, and in particular of at most 100 μm, e.g. 0.1 μm to 100 μm or 1 μm to 100 μm. Particle size refers to the mean diameter of the particles. For non-spherical particles, the diameter is defined as the longest extension of the particle.

In a specific embodiment, the dust composition comprises
(i) 0.01 to 5, preferably 0.05 to 2, more preferably 0.1 to 1% by weight, based on the total weight of the components (i), (ii) and (iii), of the at least one insecticide;
(ii) 93 to 99.99, preferably 97 to 99.94, more preferably 98.5 to 99.85% by weight, based on the total weight of the components (i), (ii) and (iii), of the at least one organic carrier; and
(iii) 0 to 2%, preferably 0.01 to 1, more preferably 0.05 to 0.5% by weight, based on the total weight of the components (i), (ii) and (iii), of the at least one fluorescent dye.

In a more specific embodiment, the dust composition comprises
(i) 0.01 to 5, preferably 0.05 to 2, more preferably 0.1 to 1% by weight, based on the total weight of the dust composition, of the at least one insecticide;
(ii) 93 to 99.99, preferably 97 to 99.94, more preferably 98.5 to 99.85% by weight, based on the total weight of the dust composition, of the at least one organic carrier; and
(iii) 0 to 2%, preferably 0.01 to 1, more preferably 0.05 to 0.5% by weight, based on the total weight of the dust composition, of the at least one fluorescent dye.

The composition of the invention is advantageously prepared by known techniques for preparing dust formulations (e.g. DP or DS). For instance, components (i), (ii), optionally (iii) and further optional components are intimately mixed and then subjected to a comminuting process, such as milling or grinding. Suitable comminuting techniques are well known to those skilled in the art and encompass, for example, the comminuting in knife mills, ball mills, hammer mills, pulverizers, fluid energy mills, colloid mills, ultra-centrifugal mills, and the like. The milling/grinding step can be followed by a further comminuting process which provides even smaller particle sizes, such as ultrasonification or cavitation.

Alternatively, the single components or a part of the components can be first comminuted separately and then be mixed with the others or with the remaining part of the components. Suitable mixing apparatuses are known to those skilled in the art and encompass, for example, drum blending machines, tumble mixers, conus mixers, and the like.

Another aspect of the invention refers to the use of the dust composition of the invention for combating insects. Using the dust composition of the invention is generally carried out as described with respect to the below methods.

A further aspect of the invention refers to a method for controlling insects, which method comprises bringing the insects, their food supply or their habitat, or the materials, soils, surfaces or spaces to be protected from insect attack or infestation into contact with a pesticidally effective amount of the dust composition of the invention.

As regards suitable and preferred embodiments of the dust composition, reference is made to the remarks made above.

The insects to be controlled by the use and the method according to the invention are preferably insects which destroy or damage industrial materials. Industrial materials in the terms of the present invention are to be understood as meaning non-living materials, such as plastics, adhesives, glues, papers and cardboards, leather, wood and timber products and paints.

More preferably, the insects to be controlled by the use and the method according to the invention are insects which destroy or damage wood and timber products, and also wood-containing buildings or parts of buildings. Wood and timber products which can be protected by the composition according to the invention are, for example, construction timber, wooden beams, railway sleepers, bridge components, jetties, wooden vehicles, boxes, pallets, containers, telephone poles, wood cladding, wooden windows and doors, plywood, particleboard, joinery articles, or wood products which, quite generally, are used in the construction of houses or boats or in joinery.

Preferably, the insects to be controlled are:

Beetles, such as

Hylotrupes bajulus, Chlorophorus pilosis, Anobium punctatum, Xestobium rufovillosum, Ptilinus pecticornis, Dendrobium pertinex, Ernobius mollis, Priobium carpini, Lyctus brunneus, Lyctus africanus, Lyctus planicollis, Lyctus linearis, Lyctus pubescens, Trogoxylon aequale, Minthes rugicollis, Xyleborus spec. Tryptodendron spec. Apate monachus, Bostrychus capucins, Heterobostrychus brunneus, Sinoxylon spec. Dinoderus minutus;

Hymenopterans, such as

Sirex juvencus, Urocerus gigas, Urocerus gigas taignus, Urocerus augur;

Termites (isopterans), such as

Calotermes spp, e.g. Calotermes flavicollis, Coptotermes spp., e.g. Coptotermes acinaciformis, Coptotermes formosanus, Coptotermes havilandi or Coptotermes lacteus, Cryptotermes spp., e.g. Cryptotermes brevis, Heterotermes spp., e.g. Heterotermes aureus or Heterotermes indicola, Leucotermes spp., e.g. Leucotermes flavipes, Mastotermes spp., e.g. Mastotermes darwiniensis, Reticulitermes spp., e.g. Reticulitermes arenicola, Reticulitermes flavipes, Reticulitermes hageni, Reticulitermes hagenus, Reticulitermes hesperus, Reticulitermes lucifugus, Reticulitermes santonensis, Reticulitermes speratus, Reticulitermes tibialis or Reticulitermes virginicus, Schedorhinotermes spp., e.g. Schedorhinotermes intermedius, Termes spp., e.g. Termes natalensis, Zootermopsis spp., e.g. Zootermopsis nevadensis;

Bristletails, such as Lepisma saccharina.

More preferably, the insects to be controlled are termites.

Bringing the insects, their food supply or their habitat, or the materials, soils, surfaces or spaces to be protected from insect attack or infestation into contact with a pesticidally effective amount of the dust composition of the invention is generally carried out by distributing a sufficient, i.e. a pesticidally effective amount, of the dust composition of the invention on the insects themselves, on their food supply or their habitat, or the materials, soils, surfaces or spaces to be protected from insect attack or infestation. The distribution is carried out by known techniques for distributing a dust, such as dispersing, spreading, scattering, dusting, blowing, puffing and the like.

The pesticidally effective amount depends on several factors, for example on the object which is treated, on the environmental conditions, such as humidity or air current, on the insect species and on the insect pressure and can be determined in each case by the skilled person.

Finally, the invention relates to a method for protecting wood material from termite attack or infestation, which method comprises bringing the wood material to be protected into contact with a pesticidally effective amount of the dust composition of the invention.

As to suitable and preferred embodiments of the composition of the invention, of the wood material and of the treatment method reference is made to what has been said above.

The dust composition of the invention implies a delayed mortality of the insects which have come into contact with it as compared to dust compositions of the prior art. Consequently, there is more time for a contaminated insect to come into contact with other insects and thus to spread the insecticide onto a bigger part of the insect population. The insecticidal effectivity of the composition is thus enhanced. At the same time, the overall mortality of the composition of the invention is comparable to or even higher than of compositions of the prior art. Moreover, the composition is not limited to a topical effect, it being also taken up via eating because of its content of edible cellulosic material. This is particularly useful for combating subsequent colonies of insects which often use the galleries of the antecedent colony: Leftover dust composition is eaten by the insects of the new colony and can display its insecticidal effect via a non-topic pathway, thus making a new topical application superfluous or at least delaying the need thereof. The particular embodiment of the composition additionally containing a fluorescent dye/pigment furthermore allows an easier chasing of the insects and discovery of their nest, which in turn facilitates combating them.

The invention is now illustrated by the following non-limiting examples.

### EXAMPLES

1. Preparation of the Dust Composition

1.1

A dust composition formulated as a DP (dispersible powder) containing 0.5% by weight of fipronil, 0.1% by weight of the fluorescent pigment Lumogen Yellow SO 790 (BASF AG) and 99.4% by weight of α-cellulose was prepared as follows:

Separate containers of a premix were prepared for each batch by milling and blending 15.6 g of Fipronil (used in the form of the commercially available product Termidor 80WG), 2.5 g of the Lumogen dye and approximately 100 g of α-cellulose within a KnifeTech milling apparatus (closed vessel). 2.4 g of α-cellulose were placed in a 20 l HDPE container and the contents of a pre-prepared batch load of premix were added. The mixture was then placed in a drum blending machine and blended for 1 hour.

1.2

Analogously to example 1.1 was prepared a dust composition containing 0.5% by weight of fipronil and 95.5% by weight of cellulose acetate.

2. Insecticidal Action

2.1 Laboratory Experiments

In this example, the composition of example 1.2 was used. As a comparison, a dust composition containing 0.6% by weight of arsenic trioxide on talcum powder was used.

The dust compositions were applied using two techniques, either the roll technique or the puff technique. There were ten replicates for each dust formulation, for each technique and for each species of termite.

With the roll technique, a single worker of the termite species C. acinaciformis was rolled in a small quantity (approximately 0.001 g) of one of the two dusts and introduced to 20 workers and a single soldier of the same species in a closed plastic petri dish. Moreover, a single worker of the species C. acinaciformis was rolled and dusted and observed on its own in a closed petri dish. Mortality was recorded at hourly intervals for up to 9 hours.

The same technique was used with M. darwiniensis except 10 workers and a single soldier were used. Mortality was recorded at hourly intervals for up to 22 hours.

With the puff technique, 21 workers and a single soldier of the species C. acinaciformis were dusted with a standard puff of one of the two dust formulations using a hand held termite dust puffer. The termites were kept in a closed petri dish and mortality was recorded at hourly intervals for up to 8 hours.

The same technique was used with M. darwiniensis except 10 workers and a single soldier were used. Mortality was recorded at hourly intervals for up to 23 hours.

Results:

Both dust formulations produced 100% mortality for both species either by the roll or puff technique: C. acinaciformis after 8-9 hours exposure and M. darwiniensis after 21-23 hours. Arsenic trioxide was faster to achieve 100% mortality when compared to the formulation of the invention. Thus the treatment using the formulation of the invention allows more time to further transfer the toxicant throughout the colony.

2.2 Curative Treatment of a Domestic Infestation of Mastotermes Darwiniensis with the Dust Formulation of Example 1.1

The efficacy of the dust formulation of example 1.1 as a curative treatment against baitbox aggregated Mastotermes darwiniensis was assessed in a domestic situation in Forrest Beach, north Queensland, Australia. A large population of termites that were aggregated in a bait-box filled with untreated timber were topically treated with fipronil dust via a hand-held puffer. Palm trees being attacked in close proximity were left undisturbed as monitoring points. 12 days after treatment the Mastotermes darwiniensis infestation had been eliminated.

2.3 Curative Treatment of a Domestic Infestation of Mastotermes Darwiniensis with the Dust Formulation of Example 1.1

The efficacy of the dust formulation of example 1.1 as a curative treatment against Mastotermes darwiniensis was assessed in a domestic situation in Townsville, north Queensland, Australia. A termite infestation was located in an old timber horse drawn wagon. The dust formulation of example 1.1 was topically applied to as many termites as possible using a standard hand held puffer. This was done to the wagon wheel only, the other sites remaining undisturbed for monitoring purposes. 19 days after treatment the Mastotermes darwiniensis infestation had been eliminated.

2.4 Curative Treatment of a Domestic Infestation of Coptotermes Spp. with the Dust Formulation of Example 1.1

The efficacy of the dust formulation of example 1.1 as a curative treatment against Coptotermes sp was assessed in a domestic situation in Macksville, New South Wales, Australia. An active termite infestation was located in the bathroom of a house. The dust formulation of example 1.1 was topically applied to as many termites as possible using a standard hand held puffer. 13 days after treatment the Coptotermes infestation had been eliminated.

2.5 Curative Treatment of a Domestic Infestation of Coptotermes Acinaciformis with the Dust Formulation of Example 1.1

The efficacy of the dust formulation of example 1.1 as a curative treatment against Coptotermes acinaciformis was assessed in a domestic situation in Brunswick Heads, New South Wales, Australia. Active termite infestations were located throughout the entire house. The dust formulation of example 1.1 was topically applied to as many termites as possible using a standard hand held puffer. 16 days after treatment the extensive Coptotermes acinaciformis infestation had been eliminated.

2.6 Non-Topical Application

Pest control operators reported that dust formulation of example 1.1 left over from the topical treatment was eaten by termites.

We claim:

1. A dust composition, comprising
(i) at least one insecticide selected from GABA antagonists and
(ii) α-cellulose.

2. The dust composition as claimed in claim 1, where the GABA antagonist is selected from the group consisting of acetoprole, endosulfan, vaniliprole, pyrafluprole, pyriprole, a phenylpyrazole compound of the formula II 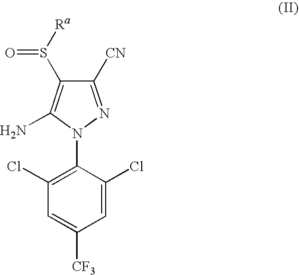
where R^{a} is C₁-C₄-alkyl or C₁-C₄-haloalkyl;
or an agriculturally acceptable salt thereof;
and a phenylpyrazole compound of the formula III 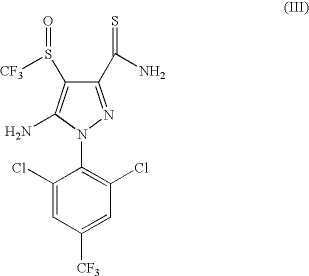
or an agriculturally acceptable salt thereof.

3. The dust composition as claimed in claim 2, where the GABA antagonist is selected from the group consisting of the phenylpyrazole compounds of the formula II.

4. The dust composition of claim 3, where R^{a} is ethyl or trifluoromethyl.

5. The dust composition of claim 2, where the GABA antagonist is fipronil.

6. The dust composition of claim 2, further comprising
(iii) at least one fluorescent dye.

7. The dust composition of claim 6, comprising
(i) 0.01 to 5% by weight, based on the total weight of the dust composition, of the at least one insecticide;
(ii) 93 to 99.99% by weight, based on the total weight of the dust composition, of α-cellulose; and
(iii) 0 to 2% by weight, based on the total weight of the dust composition, of the at least one fluorescent dye.

8. A dust composition, comprising
(i) at least one insecticide selected from GABA antagonists;
(ii) at least one organic carrier selected from celluloses and cellulose derivatives; and
(iii) at least one fluorescent dye selected from the group consisting of naphthalenes, perrylenes, terrylenes, quaterrylenes, coumarins, xanthenes, thioxanthenes, naphtholactams, azlactones, methines, thiazines and thioindigoid.

9. The dust composition as claimed in claim 8, where the at least one organic carrier is edible for insects.

10. The dust composition as claimed in claim 8, where the cellulose is α-cellulose.

11. The dust composition as claimed in claim 8, where the cellulose derivative is cellulose acetate.

12. The dust composition as claimed in claim 8, where the fluorescent dye is Lumogen Yellow SO 790.

13. The dust composition as claimed in of preceding claim 8, comprising
(i) 0.05 to 2% by weight, based on the total weight of the dust composition, of the at least one insecticide;
(ii) 97 to 99.94% by weight, based on the total weight of the dust composition, of the at least one organic carrier; and
(iii) 0.01 to 1% by weight, based on the total weight of the dust composition, of the at least one fluorescent dye.

14. The dust composition as claimed in claim 13, having a particle size of less than 400 μm.

15. (canceled)

16. (canceled)

17. A method for controlling insects which method comprises bringing the insects, their food supply or their habitat, or the materials, soils, surfaces or spaces to be protected from insect attack or infestation into contact with a pesticidally effective amount of the dust composition as defined in claim 1.

18. The method as claimed in claim 17, wherein said insect is a termite.

19. A method for protecting wood material from termite attack or infestation, which method comprises bringing the wood material to be protected or a soil, surface or space near the wood material to be protected into contact with a pesticidally effective amount of the dust composition as defined in claim 1.

20. The method of claim 19, wherein the GABA antagonist is selected from the group consisting of acetoprole, endosulfan, vaniliprole, pyrafluprole, pyriprole, a phenylpyrazole compound of the formula II 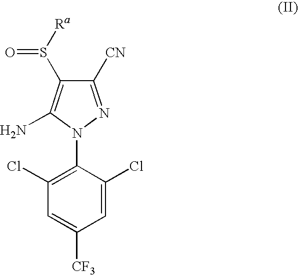
where R^{a} is C₁-C₄-alkyl or C₁-C₄-haloalkyl;
or an agriculturally acceptable salt thereof;
and a phenylpyrazole compound of the formula III 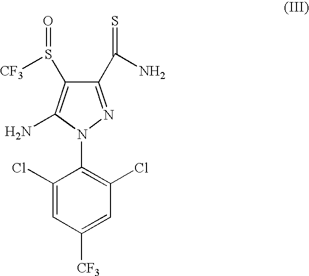
or an agriculturally acceptable salt thereof.

21. The method of claim 20, wherein the GABA antagonist is-selected from the group from the group consisting of the phenylpyrazole compounds of the formula II.

22. The method of claim 20, where the GABA antagonist is fipronil.
